(19) United States
(12) Patent Application Publication
(10) Pub. No.: US 2024/0129000 A1
(43) Pub. Date: Apr. 18, 2024

(54) FIXED BASE STATION ANTENNA SYSTEM USING DIRECTIONAL AND OMNIDIRECTIONAL ANTENNA ELEMENTS IN A MIMO CONFIGURATION

(71) Applicant: Beamlink, Inc., Pasadena, CA (US)

(72) Inventors: Arpad KOVESDY, Germantown, TN (US); Swapnil Anil SURDI, Irvine, CA (US); Mateo ABASCAL, Los Angeles, CA (US); Simran SAXENA, Los Angeles, CA (US); Johnson UNDERWOOD, San Francisco, CA (US); Akbar M. SAYEED, Madison, WI (US); Tai NGUYEN, San Jose, CA (US)

(21) Appl. No.: 18/485,632

(22) Filed: Oct. 12, 2023

Related U.S. Application Data
(60) Provisional application No. 63/415,523, filed on Oct. 12, 2022.

(51) Int. Cl. H04B 7/0413; H01Q 1/24; H04W 76/10

(52) U.S. Cl. CPC H04B 7/0413; H01Q 1/246; H04W 76/10; H04W 84/18

(57) ABSTRACT

Wireless communication techniques are disclosed. These techniques include a plurality of base stations, each of the plurality of bases stations operating in a respective area and communicating with one or more mobile stations in the respective area using a primary communication technique. One or more of the plurality of base stations are configured to communicate with a backhaul using an ad-hoc radio frequency link with another of the plurality of base stations. The ad-hoc radio frequency link utilizes an independent radio and frequency band from the primary communication technique with which the respective base station communicates with mobile stations.

This application claims the benefit of and priority to U.S. Provisional Patent Application No. 63/415,523, filed on Oct. 12, 2022, the entire contents of which are incorporated herein by reference.

### BACKGROUND

A typical base station (i.e., a radio transceiver which serves as a communication device with one or more wireless, mobile client devices) that is fixed (stationary, as opposed to mobile, which can re-locate even while transmitting or receiver) is commonly utilized in communications networks to implement a radio access network (RAN) which provides connectivity to wireless, mobile client devices (e.g., cellular devices) through one or more radio links. These base stations require backhaul, which is a link to the rest of the RAN, or to a greater public network such as the Internet.

A problem arises when implementing ad-hoc fixed wireless base stations, which can be set up without prior planning, but still serve the same function as stationary access points for mobile client devices and to implement a RAN. This problem is that the backhaul is difficult to implement, as it is typically integrated into each ad-hoc fixed wireless base station individually such as through a wired electronic connection (e.g. using copper cable, coaxial cable, or any other suitable electrical connection), a wired optical connection (e.g., using a fiber optic cable), a satellite ground station, a microwave wireless communications link, another optical communications link (e.g., an atmospheric optical link or other suitable optical communications link), or any other suitable connection. Thus, when a new base station is established, a new piece of backhaul equipment or backhaul link must also be established, which is often the most difficult part of setting up base stations in austere or rural environments.

### SUMMARY

Embodiments include a system. The system includes a plurality of base stations, each of the plurality of bases stations operating in a respective area and communicating with one or more mobile stations in the respective area using a primary communication technique. One or more of the plurality of base stations are configured to communicate with a backhaul using an ad-hoc radio frequency link with another of the plurality of base stations, and the ad-hoc radio frequency link utilizes an independent radio and frequency band from the primary communication technique with which the respective base station communicates with mobile stations.

Embodiments further include another system. The system includes a first stationary communication device, including: a radio transceiver and an antenna system. The antenna system includes a directional antenna communicatively coupled to the radio transceiver and an omni-directional antenna communicatively coupled to the radio transceiver. The antenna system extends a physical range of a wireless radio link from the first stationary communication device to a second stationary communication device through use of the directional antenna and the omni-directional antenna.

Embodiments further include a further system. The system includes a first stationary communication device, including a cellular base station and a cellular user equipment transceiver. The cellular user equipment transceiver is configured to communicate wirelessly with other nearby stationary communication devices. The cellular user equipment transceiver is capable of communicating bi-directionally with the cellular base station. The cellular user equipment transceiver is configured to operate on one or more different channels from the cellular base station to avoid interference, and the cellular base station is configured to communicate with a backhaul using a first network protocol which allows data to be forwarded to the backhaul from the cellular base station through the cellular user equipment transceiver and returned from the backhaul to the cellular base station through the cellular user equipment transceiver.

### DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 is a functional diagram depicting a Multiple-Input Multiple-Output (MIMO) configuration, according to one embodiment.

FIG. 2 a functional diagram depicting a modified MIMO configuration for fixed wireless base stations, according to one embodiment.

FIG. 3 illustrates a geospatial representation of antenna beams implementing a modified MIMO configuration for fixed wireless base stations, according to one embodiment.

FIG. 4 illustrates a base station and mobile station for a modified MIMO configuration for fixed wireless base stations, according to one embodiment.

FIG. 5 is a flowchart illustrating establishing an ad-hoc backhaul connection for a modified MIMO configuration for fixed wireless base stations, according to one embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In an embodiment, a fixed (e.g., stationary) point-to-point radio link can be established using a system of omni-directional and directional antennas to extend the distance between two base stations (e.g., cellular network base stations) that communicate in an ad-hoc network configuration. This can reduce logistical requirements by only requiring one out of two antennas, per link, to be pointed in a specified direction, and can be implemented by utilizing uplink and downlink Multi-User MIMO (MU-MIMO) techniques. In an embodiment, after establishing the fixed base station, the base station's antenna configuration or position does not need to be changed to add additional base stations into the RAN.

In more detail, one or more embodiments integrate backhaul into each base station by utilizing an ad-hoc connection between base stations, which allows each base station to act as a relay, forwarding data backwards across the ad-hoc links until a base station that has direct backhaul access is reached. In an embodiment, this system allows a wider group of base stations providing data access in an area to have only a fraction of the base stations connected to backhaul. For example, the backhaul connection can be an Ethernet connection (e.g., via coaxial cable, copper cable, or another suitable electrical connection cable), optical connection (e.g., via fiber optic cable or atmospheric optical link), microwave point-to-point link, satellite ground station, or any other suitable connection. One or more embodiments utilize a radio frequency (RF) link that is independent of the primary service that the base station is providing. In this manner, the dedicated, ad-hoc independent RF link is not subject to traffic or interference from user devices, and therefore, is immune from congestion-related issues and denial of service attacks on any particular base station, which would cripple all of the base stations downstream of the ad-hoc connection.

In one embodiment, a cellular base station provides cellular services to nearby mobile stations, and contains a dedicated RF communication link to nearby base stations which utilizes ad-hoc mesh network technology to establish communication links (e.g., without a requirement for a predetermined routing table configuration or user intervention). In this embodiment, an 802.11 protocol can be utilized to operate on a band without a requirement for a license. In most austere environments, such as environments after a natural disaster or other catastrophe crippling existing RANs and rural environments where no, or limited, cellular infrastructure exists, there will be lower interference on these bands than typical urban deployments, allowing the 2.4 GHz and 5 GHz 802.11 bands to be utilized for communication with high reliability. The latest 802.11 standards also provide the necessary data throughput to allow data relaying of large amounts of data traffic (e.g., in both uplink and downlink directions) from multiple mobile stations and other base stations in the area that are forwarding traffic through the RAN.

In another embodiment, a cellular protocol can be used for an RF communication link between base stations to transfer data between base stations. The cellular protocol can be any suitable cellular protocol, including a global system for mobile communications (GSM) protocol, a general packet radio service (GPRS) protocol, a universal mobile telecommunications system (UMTS) protocol, a long-term evolution (LTE) protocol, a 5G new radio (5G-NR) protocol, or any other suitable cellular protocol. For example, cellular protocols may typically be used with little interference thanks to stricter licensing requirements, which allows for higher transmission power than the aforementioned unlicensed bands. In this embodiment, each base station contains a transceiver module (e.g., similar to the radios used in user equipment like Internet of Things (IoT) devices or smartphones) called its mesh network transceiver, in addition to the main transceiver used for base station functions. The transceiver module connects to other base stations nearby. In an embodiment, this provides an RF communication link between multiple base stations, providing a wireless link to establish a mesh network between the base stations. By utilizing the Quality of Service (QoS) mechanism and packet prioritization features typically onboard each base station, the base station to base station wireless links can be favored over typical user equipment operating in the same band, improving throughput and reducing latency and guaranteeing adequate backhaul performance for each base station. Furthermore, since each base station typically operates at different channels, the base station's main transmitter will not interfere with its mesh network transmitter. In one embodiment, the use of cellular protocols for the RF connection between base stations does not require additional changes to the firmware of each base station or implementation of Integrated Access Backhaul. In another embodiment of the RF communication link between base stations, the cellular protocol may be implemented using Integrated Access Backhaul (IAB) protocols defined within 3GPP TS 38.340.

One potential downside of one or more of these technique is that there may be additional latency and potential loss from relaying communications traffic across multiple base stations as each base station de-modulates and modulates these transmissions. Additionally, each base station should be “in range” of another base station, meaning that the radio transceiver should be able to receive and transmit with reliable condition to a nearby base station. However, due to free-space path loss, which is the attenuation between two antennas in free space of a signal as the two antennas are separated physically, the effectiveness of such an ad-hoc backhaul configuration is limited, and each base station must be placed in physical proximity to one another per the limitations of free-space path loss and line of sight (e.g., considering terrain, weather, and other factors).

One or more embodiments overcome the limitations of ad-hoc backhaul configurations for fixed wireless base stations by utilizing two or more antennas that may both transmit and receive. The embodiments discussed herein focus on a two antenna configuration, for simplicity of description. But this is merely an example, and any suitable number of antennas could be used (e.g., three antennas, four antennas, or any other suitable number of antennas).

In an embodiment, a multi-antenna system utilizes MU-MIMO techniques for communications. For example, multiple antennas can be used per given radio transceiver. Using uplink MU-MIMO (as well as downlink MU-MIMO), multiple base stations may independently communicate to each base station utilizing different antennas. As one example, transmit beamforming can be used to allow multiple antennas transmitting at phase offsets to dynamically control the antenna radiation pattern into distinct beams that reach different users that are physically located at different places.

However, in this embodiment, an antenna system includes two sets of antennas. This antenna system can include one set of static, omni-directional antennas, and one set of static, directional antennas. For this embodiment, one omni-directional antenna and one directional antenna are utilized for one transceiver. This is merely an example. Multiple antennas for both sets, or any other suitable configuration, may be also utilized. As one example, static antennas do not change their radiation pattern with time. Omni-directional antennas may have a certain radiation pattern that allows communication with other devices at any physical location around the antenna and have a low antenna gain, near unity gain. Directional antennas can have a certain radiation pattern that only allows communication with other devices at a certain pre-determined location. Examples of directional antennas include dish, panel, and Yagi antennas. The advantage of directional antennas is that they typically have higher gain than omni-directional antennas. This increased gain can offset the path losses and other losses described above.

In another embodiment, the system may be compromised of an omni-directional antenna and an electronically steered antenna array to provide a dynamically (time dependent) changing beam that directs energy into a specific direction towards other base stations nearby where the electronically steered antenna array replaces the directional antenna. In one embodiment, a Butler Matrix antenna, comprised of an array of antenna elements implemented as microstrip transmission lines embedded on a printed circuit board substrate. In one embodiment, the printed circuit board will contain an eight-element circular array excited by eight input ports that are connected to a low-cost single pole, eight throw (SP8T) radio frequency switching integrated circuit (RFIC), although greater or fewer antenna elements may be used connected to an RFIC with a different number of throw positions. The antenna elements provide 8 distinct beam directions in the azimuth direction, equally spaced 45 degrees apart. This design removes the requirement of expensive hybrid modules and RF phase shifter integrated circuits that most electronically steered antenna arrays require. A theoretical maximum of 9 dBi gain may be achieved per antenna array, while not requiring manual modification or re-positioning by the user. In this embodiment, each base station may have an electronically steered array connected to replace the directional antenna, providing a total theoretical gain of 18 dBi in the system. Further, in this embodiment, the electronically steered array implements a software algorithm for selecting the input port connected to the RFIC. In a scanning mode, the antenna switches sequentially between the antenna ports and gathers data for each antenna port until a sufficient signal is detected. In this scanning mode, only the receiver of the radio is utilized. Once a sufficient signal is detected, the input port is maintained on the input port where the strong signal is detected to establish an RF communications link (the “transceiver mode”).

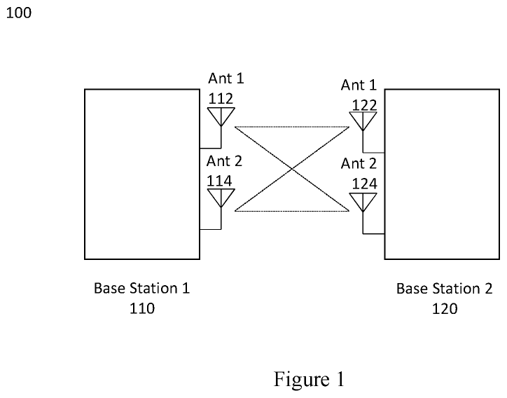

FIG. 1 describes an antenna system 100 with two base stations 110 and 120. A first base station 110 has two antennas 112 and 114. A second base station 120 has two antennas 122 and 124. In an embodiment, each of the four antennas 112, 114, 122, and 124 are capable of transmitting and receiving with the same antenna. The dotted lines indicate paths that information may flow as it is received and transmitted between two antennas through space.

In an embodiment, the antenna system 100 illustrates an implementation of MIMO where multiple antennas may communicate to multiple other antennas on another device (e.g., a base station, access point, or mobile device). These MIMO systems typically have the goal of reducing the effects of multipath propagation by using multiple streams of data between the receiver and transmitter, increasing throughout in a communications link and protecting against lost packets due to fading.

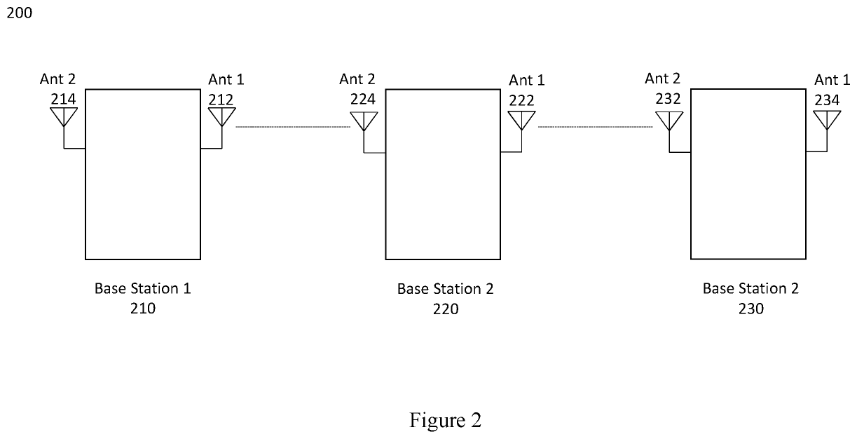

FIG. 2 describes an antenna system 200 with three base stations 210, 220, and 230. In an embodiment, each base station 210, 220, and 230 includes two antennas in the same configuration as the antenna system 100 illustrated in FIG. 1. However, in an embodiment, instead of a typical MIMO configuration, a single-input/single output (SISO) configuration is utilized where each base station 210, 220, and 230 communicates with one other antenna of a nearby base station. For example, the base station 210 communicates with the base station 220 using the antennas 212 and 224, while the base station 220 communicates with the base station 230 using the antennas 222 and 232. Note that in this example there are only two antennas per base station, however, there could be theoretically any number of antennas connected to each base station transmitting and receiving to any number of neighboring base stations. Further, each antenna could also be transmitting to, and receiving from, more than one base station in other embodiments.

In an embodiment, the antenna system 200 described in FIG. 2 represents a modification to the antenna system 100 FIG. 1, where although each base station contains multiple antennas, each antenna communicates with a base station at another physical location through a single antenna (e.g., using SISO). This is merely an example. In other embodiments, multiple base stations transmit and receive to a single antenna of another base station. In an embodiment, the antenna system 200 increases the total gain of the communications link between base stations (e.g., between two base stations). However, unlike a traditional directional communications link where both antennas must be pointed towards each other, only one directional antenna must be pointed in the direction of the corresponding base station. This advantage allows already established base stations to be left unperturbed while newly established base stations only need to be configured once manually using a pointing operation. In the case of an electronically steered antenna array replaces the directional antenna, the antenna pointing operation is not required, and is replaced by a software algorithm that uses a previously described scanning mode to determine the correct beam direction.

In an embodiment, the pointing operation consists of turning, rotating, or otherwise moving the antenna element that is utilized as the directional antenna, in a manner so that the antenna's beam is centered towards the nearest base station, or base station that is nearest to an available backhaul, as the operator sees most advantageous. In certain embodiments, the pointing operation could be done by the user in a manual, physical motion using the operators' hands. In this embodiment, the signal strength can be measured using an internal sensor within the base station of the antenna element. To maximize the received signal strength from other nearby base station transmitters for this ad-hoc RF link, a visual indication (e.g., an LCD display) displays the received signal strength to the operator. The operator can then modify the direction that the antenna points and read the received signal strength once more, repeating the operation until the signal strength reaches its highest or desired level. If no signal can be attained by the operator, the operator may consider moving the base station into another area for better signal reception, or moving the base station physically closer to other base stations. In other embodiments, the data regarding the received signal strength can be transmitted using an application programming interface (API) to another server or remote repository where the data is stored and presented to the user through a remote interface (e.g., a web-accessible interface or smartphone application, or any other suitable remote interface). The data can be transmitted using any suitable communication network, including the Internet, a direct connection, or any suitable wired or wireless connection.

Alternatively, or in addition, the pointing operation is performed by a motor (e.g., connected in one, two, or three axes of motion) with respect to an antenna mounting point. The antenna mounting point can be the point where the antenna element connects to the cable, fixture, or overall unit (e.g., through a hinge mechanism). In an embodiment, the motor connects via electrical wires to the base station casing and can be controlled by a software program operating in the base station, by an external circuit located outside of the base station casing, or using any other suitable technique. In this embodiment, a signal sent by the internal computer within the base station actuates the motor. The antenna turns by rotating across the hinge mechanism. The base station that takes a reading of the signal strength of the received signal by the antenna element. The motor continues to turn in a direction determined by the internal computer software in a manner to achieve the highest signal strength at the antenna element.

In another case in the same embodiment, as also shown in FIG. 2, the omni-directional antenna can directly communicate with the omni-directional antenna of the nearby base station. Since antenna diversity is implemented (e.g., using multiple antennas to improve the quality or capability of a wireless radio link), any antenna may be utilized to interface with the wireless transceiver. Since uplink MU-MIMO is utilized, not only may the access point (e.g., base station) transmit concurrently to multiple receivers, but it can also receive from multiple external transmitters simultaneously, even if those transmissions are sent to different antennas in the system.

One or more of these techniques have numerous advantages. For example, the techniques discussed above can provide an increase in the gain, and therefore range, that the base stations may be placed apart. The range can be calculated from an equation factoring in the power transmitted from the transceiver, receiver sensitivity, frequency of the radio wave, transmitting antenna gain, receiving antenna gain, and other optional knockdown factors factoring in height of the transmitter and receiver, weather factors, terrain, and others. For example, given a 5.15 to 5.25 GHz frequency band, IEEE 802.11ax wireless radio link which supports uplink MU-MIMO, the transmitter power for a fixed point-to-point link is limited to 30 dBm which is equal to 1 Watt of transmitter power fed to the input of the antenna according to the F.C.C. Code, Part 15 as of 2023 for unlicensed wireless transmission equipment. However, an additional 23 dBi of antenna gain may be utilized for the directional antenna, giving an equivalent of 53 dBm maximum Equivalent, Isotropically Radiated Power (EIRP), substantially increasing the range at which the two base stations may be placed apart without causing undue harm from interference. The cost to establishing such a system is the pointing operation required from one of two or more base stations when fixed directional antenna are utilized or additional cost of using an electronically steered antenna array.

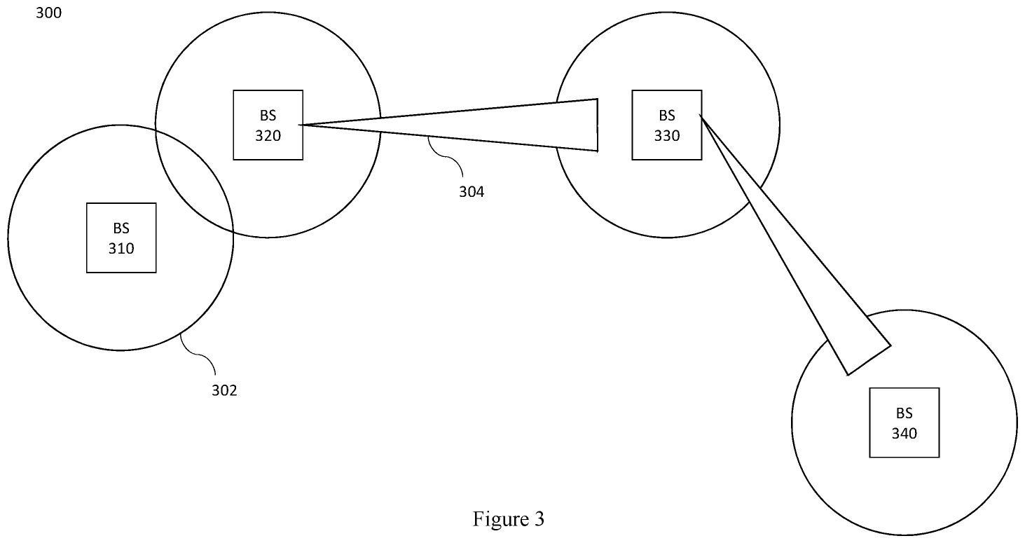

FIG. 3 illustrates a geospatial representation of antenna beams implementing a modified MIMO configuration for fixed wireless base stations, according to one embodiment. In an embodiment, FIG. 3 shows a top-down representation of a communication system 300 including wireless communication links, with the various geometries representing the maximum range of each communication link before it is attenuated to a power level below which the receiver may decode the traffic contained in the communications link. The system 300 includes base stations 310, 320, 330, and 340, an omni-directional antenna element 302 and a directional antenna element 304. In an embodiment, the leftmost base station 310 does not utilize a directional antenna because the omni-directional antenna 302 is close enough that a communications link can be established between two omni-directional antennas. The three other base stations 320, 330, and 340 communicate via a directional to omni-directional antenna system to increase the total EIRP and allow the base stations to be placed further apart physically.

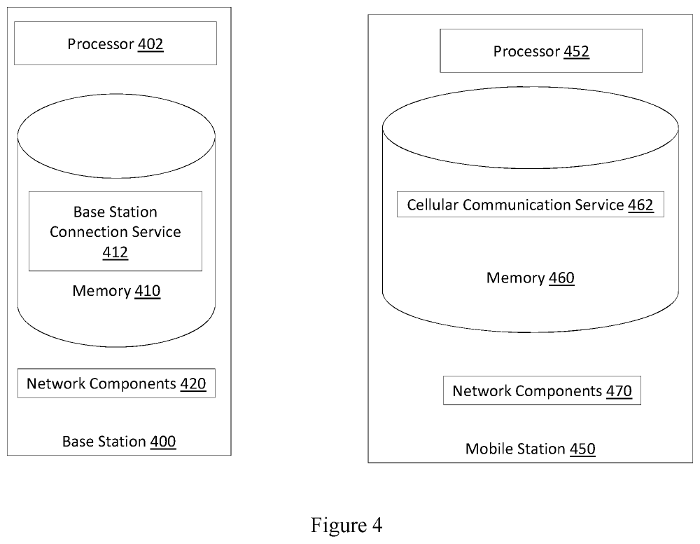

FIG. 4 illustrates a base station 400 (e.g., a cellular base station) and mobile station 450 for a modified MIMO configuration for fixed wireless base stations, according to one embodiment. In an embodiment, the base station 400 corresponds with any of the base stations 110 and 120 illustrated in FIG. 1, the base stations 210, 220, and 230 illustrated in FIG. 2, and the base stations 310, 320, 33, and 340 illustrated in FIG. 3. The base station 400 includes a processor 402, a memory 410, and network components 420. The processor 402 generally retrieves and executes programming instructions stored in the memory 410. The processor 402 is representative of a single central processing unit (CPU), multiple CPUs, a single CPU having multiple processing cores, graphics processing units (GPUs) having multiple execution paths, and the like.

The network components 420 include the components necessary for the base station 400 to interface with a communication network, as discussed above in relation to FIGS. 1-3. For example, the network components 420 can include WiFi or cellular network interface components and associated software, including suitable antennas as discussed above in relation to FIGS. 1-3. Although the memory 410 is shown as a single entity, the memory 410 may include one or more memory devices having blocks of memory associated with physical addresses, such as random access memory (RAM), read only memory (ROM), flash memory, or other types of volatile and/or non-volatile memory.

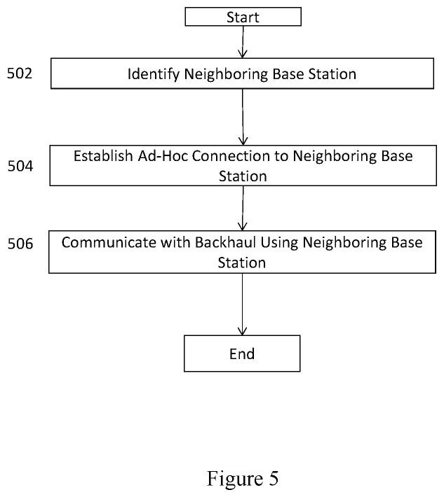

The memory 410 generally includes program code for performing various functions related to use of the base station 400. The program code is generally described as various functional “applications” or “modules” within the memory 410, although alternate implementations may have different functions and/or combinations of functions. Within the memory 410, the base station connection service 412 facilitates communication by the base station 400 with a backhaul (e.g., using an ad-hoc connection to another base station). This is discussed further, above, with regard to FIGS. 1-3, and below with regard to FIG. 5.

The mobile station 450 includes a processor 452, a memory 460, and network components 470. In an embodiment, the mobile station 450 is associated (e.g., communicatively coupled using a cellular connection) with the base station 400. The mobile station 450 can be any suitable mobile station, including a smartphone, a tablet, a laptop computer, a desktop computer, an IoT device, a wearable device, or any other suitable device. The processor 452 generally retrieves and executes programming instructions stored in the memory 460. The processor 452 is representative of a single central processing unit (CPU), multiple CPUs, a single CPU having multiple processing cores, graphics processing units (GPUs) having multiple execution paths, and the like.

The network components 470 include the components necessary for the mobile station 450 to interface with a wireless communication network, as discussed above in relation to FIGS. 1-3. For example, the network components 470 can include WiFi or cellular network interface components and associated software (e.g., cellular network interface components suitable to interact with the base station 400). Although the memory 460 is shown as a single entity, the memory 460 may include one or more memory devices having blocks of memory associated with physical addresses, such as random access memory (RAM), read only memory (ROM), flash memory, or other types of volatile and/or non-volatile memory.

The memory 460 generally includes program code for performing various functions related to use of the mobile station 450. The program code is generally described as various functional “applications” or “modules” within the memory 460, although alternate implementations may have different functions and/or combinations of functions. Within the memory 460, the cellular communication service 462 facilitates communicating with a cellular base station (e.g., the base station 400).

FIG. 5 is a flowchart 500 illustrating establishing an ad-hoc backhaul connection for a modified MIMO configuration for fixed wireless base stations, according to one embodiment. At block 502, a base station connection service (e.g., the base station connection service 412 illustrated in FIG. 4). For example, as discussed above in relation to FIGS. 1-3, the base station connection service can operate at a base station and can identify neighboring base stations with which to establish a connection (e.g., for communication with a backhaul).

At block 504, the base station connection service establishes an ad-hoc connection to a neighboring base station. In an embodiment, as discussed above, the base station connection service establishes an ad-hoc connection to a neighboring base station (e.g., a suitable wireless connection to a neighboring base station). In an embodiment, any of the antenna configurations and techniques discussed above in relation to FIGS. 1-3 can be used to establish the ad-hoc connection to the neighboring base station.

At block 506, the base station connection service communicates with a backhaul using the neighboring base station. In an embodiment, the ad-hoc connection between neighboring base stations allows the neighboring base station to act as a relay, forwarding data across the ad-hoc links until a base station that has direct backhaul access is reached. For example, the neighboring base station might itself have direct backhaul access. As another example, the neighboring base station might itself have an ad-hoc connection to another base station, eventually leading to direct backhaul access. As noted above, in an embodiment, any of the antenna configurations and techniques discussed above in relation to FIGS. 1-3 can be used to establish the ad-hoc connection to the neighboring base station and communicate with the backhaul.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a computer, a special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system, comprising:
a plurality of base stations, each of the plurality of bases stations operating in a respective area and communicating with one or more mobile stations in the respective area using a primary communication technique, wherein
one or more of the plurality of base stations are configured to communicate with a backhaul using an ad-hoc radio frequency link with another of the plurality of base stations, and
wherein the ad-hoc radio frequency link utilizes an independent radio and frequency band from the primary communication technique with which the respective base station communicates with mobile stations.

2. The system of claim 1, wherein the one or more of the plurality of base stations further communicates with the backhaul using a dedicated connection, comprising at least one of: (i) a microwave RF link, (ii) a wired electronic connection, (iii) an optical connection, or (iv) a satellite ground station connection.

3. The system of claim 2, wherein the optical connection comprises at least one of a fiber optic connection or an atmospheric optical connection.

4. The system of claim 1, wherein the ad-hoc radio frequency link is on a dedicated communications link.

5. A system, comprising:
a first stationary communication device, comprising:
a radio transceiver; and
an antenna system comprising:
a directional antenna communicatively coupled to the radio transceiver; and
an omni-directional antenna communicatively coupled to the radio transceiver,
wherein the antenna system extends a physical range of a wireless radio link from the first stationary communication device to a second stationary communication device through use of the directional antenna and the omni-directional antenna.

6. The system of claim 5, wherein the first and second communications devices each comprises one of a base station or an access point.

7. The system of claim 6,
wherein the directional antenna is a higher gain antenna compared with the omni-directional antenna, and
wherein the directional antenna requires directing to point and the omni-directional antenna does not require directing to point.

8. The system of claim 7, wherein the antenna system is configured to allow multiple stationary communication devices to communicate with the first stationary communication device through the radio transceiver using Multi-User Multiple-Input/Multiple-Output (MU-MIMO).

9. The system of claim 8, wherein the antenna system uses both uplink and downlink MU-MIMO, utilizing multiple independent data streams across multiple antenna elements.

10. The system of claim 9, wherein the first stationary communication device establishes a communication link with the second stationary communication device through one of: (i) an omni-directional antenna to omni-directional antenna connection or (ii) an omni-directional antenna to directional antenna connection.

11. The system of claim 6, wherein the directional antenna is an electronically steered antenna array, and
wherein the electronically steered antenna array uses a Butler Matrix design which utilizes microstrip transmission lines embedded into a printed circuit board substrate.

12. The system in claim 11, wherein a radio frequency integrated circuit switches between antenna ports of the Butler matrix to select an azimuthal direction of transmission and reception of the directional antenna.

13. The system of claim 12, wherein the Butler Matrix is controlled using a software algorithm that switches between scanning and transmission modes.

14. A system, comprising:
a first stationary communication device, comprising:
a cellular base station; and
a cellular user equipment transceiver,
wherein the cellular user equipment transceiver is configured to communicate wirelessly with other nearby stationary communication devices,
wherein the cellular user equipment transceiver is capable of communicating bi-directionally with the cellular base station, and
wherein the cellular user equipment transceiver is configured to operate on one or more different channels from the cellular base station to avoid interference, and
wherein the cellular base station is configured to communicate with a backhaul using a first network protocol which allows data to be forwarded to the backhaul from the cellular base station through the cellular user equipment transceiver and returned from the backhaul to the cellular base station through the cellular user equipment transceiver.

15. The system of claim 14, wherein the first network protocol comprises a mesh network protocol.

16. The system of claim 15, wherein the cellular user equipment transceiver communicates using a cellular protocol shared by user equipment.

17. The system of claim 16, wherein the cellular protocol comprises at least one of: (i) a global system for mobile communications (GSM) protocol, (ii) a general packet radio service (GPRS) protocol, (iii) a universal mobile telecommunications system (UMTS) protocol, (iv) a long-term evolution (LTE) protocol, or (v) a 5G new radio (5G-NR) protocol.

18. The system of claim 15,
wherein the cellular user equipment transceiver connects to a second stationary communication device comprising a bases station, and
wherein the cellular user equipment transceiver connects to a second cellular user equipment transceiver contained within the second stationary communication device, allowing for data to be sent from the first station communication device to a third destination stationary communication device multiple wireless links away from the first stationary communication device via the second stationary communication device.

19. The system of claim 15, wherein the cellular base station is configured to communicate with the backhaul through the cellular user equipment transceiver without any of: (i) microwave RF link, (ii) a wired electronic connection, (iii) an optical connection, or (iv) a satellite ground station connection.
